(19) United States
(12) Patent Application Publication
(10) Pub. No.: US 2023/0151498 A1
(43) Pub. Date: May 18, 2023

(54) METAL OXIDE CATALYSTS AND METHODS FOR PRODUCING AMMONIA

(71) Applicant: HASKOLI ISLANDS, Reykjavik (IS)

(72) Inventor: Egill SKULASON, Reykjavik (IS)

(21) Appl. No.: 16/645,243

(22) PCT Filed: Sep. 10, 2018
(86) PCT No.: PCT/IS2018/050008

§ 371 Date: Mar. 6, 2020

(30) Foreign Application Priority Data
Sep. 8, 2017 (IS) 50188

(51) Int. Cl. C25B 1/27; C25B 11/077; C25B 9/13; C25B 11/081; C25B 15/08; C25B 1/04

(52) U.S. Cl. CPC C25B 1/27; C25B 1/04; C25B 9/13; C25B 11/081; C25B 11/0775; C25B 15/08

(57) ABSTRACT

The invention relates to a process and system for electrolytic production ammonia. The process comprises feeding nitrogen to an electrolytic cell, where it comes in contact with a cathode electrode surface, wherein said surface has a catalyst surface comprising at least one transition metal oxide, the electrolytic cell further comprising a proton donor, and running a current through said electrolytic cell, whereby nitrogen reacts with protons to form ammonia. The process and system of the invention uses an electrochemical cell with a cathode surface having a catalytic surface that is preferably charged with one or more of Rhenium oxide, Tantalum oxide and Niobium oxide.

### FIELD

The invention is within the field of process chemistry, and specifically relating to production of ammonia with electrolytic methods, and new catalysts therefor.

### INTRODUCTION

Ammonia is one of the most highly produced chemicals worldwide. The industrial ammonia synthesis recognized nowadays as the Haber-Bosch process is the first heterogeneous catalytic system, a key element of the global industrial production of nitrogen fertilizer. Today, ammonia is also gaining attention as a possible energy carrier and a potential transportation fuel with high energy density but no CO₂ emission. The centralized and energy demanding Haber-Bosch process requires high pressure (150-350 atm) and high temperature (350-550° C.) to directly dissociate and combine nitrogen and hydrogen gas molecules over a ruthenium or iron based catalyst to form ammonia, by the following reaction:

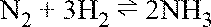

A drawback of this industrial approach is the high temperature and pressure needed for kinetic and thermodynamic reasons. Another drawback and a more serious one is that the hydrogen gas is produced from natural gas. That multi-step process takes up the largest part of the whole chemical plant, and is the most costly and unfriendly with regards to the environment. That is the largest reason that a sustainable process is needed, since the natural gas will at some point be depleted. A small-scale system for decentralized ammonia production that uses less energy and ambient conditions would therefore be of great significance. Further, in order to optimise the efficiency of ammonia synthesis, new catalysts capable of hydrogenating dinitrogen at reasonable rate but at milder conditions will be much appreciated.

The triple bond in molecular nitrogen N₂ is very strong and as a consequence nitrogen is very inactive and frequently used as an inert gas. It is broken down by the harsh conditions in the Haber-Bosch process, however, it is also broken down at ambient conditions in a natural process, by microorganisms through nitrogenase enzyme. The active site of nitrogenease is a MoFe₇S₉N cluster that catalyzes ammonia formation from solvated protons, electrons and atmospheric nitrogen through the electrochemical reaction

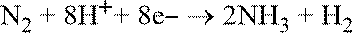

Inspired by nature, biological nitrogen fixation as an alternative approach to the Haber-Bosch process for synthesizing ammonia under ambient conditions has been attracting much attention. Much effort has been on research trying to develop similar electrochemical processes. Various methods for ammonia synthesis at ambient conditions have been explored in the last decades. (Giddey S, Int J Hydrogen Energy 2013, 38, 14576-14594; Amar A, J Solid State Electrochem 2011, 15, 1845-60; Shipman MA, Catalysis Today 2017, 286, 57-68). While such studies have provided insight into the process of ammonia formation, the kinetics are still too slow for practical applications and in most cases hydrogen gas is dominantly formed more readily than protonation of nitrogen. The reduction of dinitrogen by protons and electrons to selectively form ammonia at room temperature and pressure has proven much more challenging than expected.

The inventors have previously established (WO 2015/189865) that certain metal nitride catalysts may be employed in electrochemical processes for producing ammonia. It remains however unestablished whether other or additional metal compounds can be useful in the production of ammonia. Other efforts towards artificial synthesis of ammonia, using electrochemical methods, have yielded relatively low current efficiencies (CE). For many of these, regenerating the active nitrogen-fixing complex has proved problematic, and production rates far from reaching commercial viability.

### SUMMARY

The above features along with additional details of the invention, are described further in the examples below, which are intended to further illustrate the invention but are not intended to limit its scope in any way.

The present inventors have found that certain transition metal oxide catalysts may be employed in electrochemical processes for producing ammonia. This has lead to the present invention, that makes possible ammonia production at ambient room temperature and atmospheric pressure.

The present invention provides a process for producing ammonia comprising feeding N₂ to an electrolytic cell that comprises at least one source of protons; allowing the N₂ to come into contact with a cathode electrode surface in the electrolytic cell, wherein the cathode electrode surface comprises a catalyst surface comprising at least one transition metal oxide; and running a current through said electrolytic cell, whereby nitrogen reacts with protons to form ammonia.

The invention also provides a system for the generation of ammonia, in particular a system that carries out the method of generating ammonia as disclosed herein. Thus, the invention provides a system for generating ammonia, the system comprising at least one electrochemical cell, the at least one electrochemical cell comprising at least one cathode electrode having a catalytic surface, wherein the catalytic surface is charged with at least one catalyst comprising one or more transition metal oxide.

In the method and system in accordance with the invention, the transition metal oxide can be selected from the group consisting of Titanium oxide, Chromium oxide, Manganese oxide, Niobium oxide, Tantalum oxide, Ruthenium oxide, Rhodium oxide, Platinum oxide, Osmium oxide, Rhenium oxide and Iridium oxide. In some preferred embodiments, the oxide is selected from the group consisting of Rhenium oxide, Tantalum oxide and Niobium oxide.

The catalyst surface can comprises at least one surface having a rutile structure, in particular a rutile structure having a (110) facet on which the catalytic ractions take place. In some embodiments,. the catalyst comprises a surface having bridging sites between sixfold coordinated transition metal atoms that are covered by hydrogen atoms.

### BRIEF DESCRIPTION OF THE FIGURES

The skilled person will understand that the figures, described below, are for illustration purposes only. The figures are not intended to limit the scope of the present teachings in any way.

FIG. 1 shows three different surfaces at a (110) facet. (a) The reduced surface is on the left, where the bridging sites between the sixfold coordinated metal atoms are left vacant. The bridging sites and the cus sites are marked on the picture of the reduced surface. (b)The 0.5 ML hydrogen terminated surface is the structure in the center, where hydrogen atoms occupy the br-sites. (c) The 0.5 ML oxygen terminated surfaces is then depicted on the right, where oxygen occupies the br-sites instead of hydrogen.

FIGS. 2-12 show relative stability of adsorbates formed by proton reduction and water oxidation on various transition metal oxide (110) surfaces in a rutile structure. The top (flat) line on each diagram shows the reduced surface, used as a reference, where all the bridge oxygen atoms have been reduced to H₂O. Shown are relative stabilities of adsorbates for the (110) facets of NbO₂, TiO₂, TaO₂, ReO₂, IrO₂, OsO₂, CrO₂, MnO₂, RuO₂, RhO₂ and PtO₂ respectively.

FIG. 13 shows a free energy diagram for NH₃ formation on the (110) facet of NbO₂ rutile. The potential determining step (PDS) for the hydrogen terminated surface is the first protonation step whereas the PDS for the oxygen terminated and the reduced surfaces is the last protonation step, from *NH₂ to NH₃. All reaction steps are referenced to the clean surface and N₂ and H₂ in the gas phase. Gaseous ammonia desorption is denoted by arrows. The black colored intermediate applies to the surfaces where no other intermediate is specified, whereas an intermediate of colors other than black, only apply to that specific surface.

FIGS. 14-23 show free energy diagrams for electrochemical ammonia formation on the (110) facets of TiO₂, TaO₂, ReO₂, IrO₂, OsO₂, CrO₂, MnO₂, RuO₂, RhO₂ and PtO₂, respectively, all in the rutile structure.

FIG. 24 shows the predicted onset potentials (ΔG = -U) for each of the differently terminated oxide surfaces; hydrogen terminated, oxygen terminated and reduced. The wider columns (to the left of the onset potentials for each oxide) show the favored surface termination (ST) as the applied potential is varied, where the potential is shown on the y-axis. The oxides are ordered from left to right by the increasing magnitude of the potential determining step (PDS) on the hydrogen terminated surface.

FIGS. 25-35 show free energy diagrams for NH₃ formation on the H-term surface of the 11 different rutile oxides. All reaction steps are referenced to the clean surface and N₂ and H₂ in the gas phase. For each reaction step, all stable intermediate are shown

FIG. 36 shows the potential determining step of electrochemical ammonia formation on each metal oxide, plotted against the binding energy of N₂H on the metal. The lines are calculated using scaling relations, shown in FIGS. 26-28.

FIG. 37 shows the potential determining step of electrochemical ammonia formation on each metal oxide is plotted against the binding energy of N₂H on the metal. The lines are calculated using the scaling relations depicted in FIGS. 38-43. The figure depicts a volcano diagram, similar to FIG. 36, whereas in FIG. 37 all the reaction steps are shown.

FIGS. 38-41 show adsorption energies of NHNH, NNH₂, NHNH₂, NH₂NH₂, NH₂+NH₂, NH+NH₃ and NH₂ as a function of the chemisorption energy of NNH. The equation of the best line through the data set is given for each adsorbate.

FIG. 42 shows adsorption energies of N as a function of the chemisorption energy of N₂H. The equation of the best line through the data set is given for each adsorbate.

FIG. 43 shows adsorption energies of NH and NH₂ as a function of the chemisorption energy of N₂H. The equation of the best line through the data set is given for each adsorbate.

FIG. 44 shows the potential determining step of each reaction step in electrochemical ammonia formation on metal oxides, plotted against the binding energy of N₂H on the metal.

### DESCRIPTION

In the following, exemplary embodiments of the invention will be described, referring to the figures. These examples are provided to provide further understanding of the invention, without limiting its scope.

In the following description, a series of steps are described. The skilled person will appreciate that unless required by the context, the order of steps is not critical for the resulting configuration and its effect. Further, it will be apparent to the skilled person that irrespective of the order of steps, the presence or absence of time delay between steps, can be present between some or all of the described steps.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

The present invention is based on the surprising discovery that on the surface of certain transition metal oxide catalysts, it is possible to form ammonia at ambient temperature and pressure with a low applied potential. Given the importance of ammonia, not least in the production of fertilizer, and the energy intensive and environmentally unfavourable conditions that are typically used during its manufacture, the invention finds important applicability in various industries.

Thus, the invention provides processes and systems for generating ammonia at ambient temperature and pressure. Ambient temperature can generally refer both to typical indoor and outdoor temperatures. Accordingly, in some embodiments the process and system of the invention is operated at a temperature in the range from about -10 ° to about 40° C., such as in the range from about 0 ° to about 40° C., such as in a range from about from about -10 ° or from about -5° C. or from about from about 0 ° or from about 4° C. or from about 5° C. or from about 8° C. or from about 10° C., to about 40° C., or to about 30° C., such as in a range of about 20-30° C. or a range of about 20-25° C. Ambient pressure refers generally to atmospheric pressure. In the process and system of the present invention, an electrolytic cell is used which can be any of a range of conventional commercially suitable and feasible electrolytic cell designs that can accommodate a special purpose cathode in accordance with the invention. Thus, the cell and system may in some embodiment have one or more cathode cells and one or more anode cells.

An electrolytic cell in the present context is an electrochemical cell that undergoes a redox reaction when electrical energy is applied to the cell.

The skilled person will appreciate that chemical compounds as described herein are provided by their chemical formula irrespective of their phase or state. In particular, compounds that are present in their gaseous state when present in a pure and isolated form at room temperature (such as N₂, H₂ and NH₃) are herein described by their chemical formula. For example, dinitrogen is herein described as N₂, whether present as nitrogen gas, as individual molecules, in clusters, bound to surfaces or present as solutes, and the same applies to other molecular species described herein.

The proton donor can be any suitable substance that is capable of donating protons in the electrolytic cell. The proton donor can for example be an acid, such as any suitable organic or inorganic acid. The proton donor can be provided in an acidic, neutral or alkaline aqueous solutions. The proton donor can also, or alternatively, be provided by H₂ oxidation at the anode. I.e. hydrogen can be considered as a source of protons: H₂ ⇔ 2(H⁺ + e⁻).

The electrolytic cell comprises at least three general parts or components, a cathode electrode, an anode electrode and an electrolyte. The overall cathode reaction can be presented as

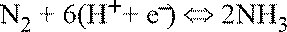

The catalyst surface can be hydrogenated by adding one hydrogen atom at a time, representing a proton from the solution and an electron from the electrode surface. The reaction mechanism can be shown in the equations below where an asterisk denotes a surface site:

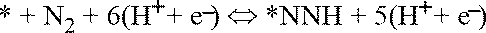

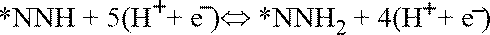

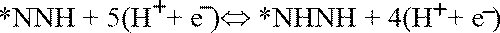

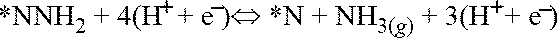

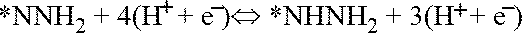

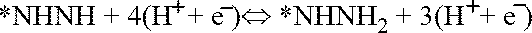

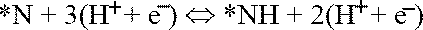

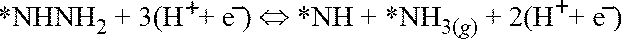

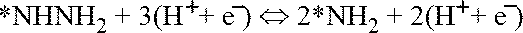

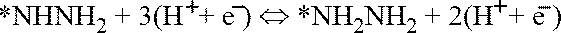

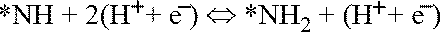

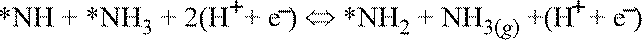

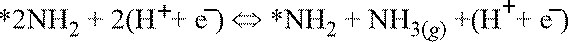

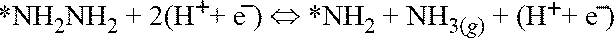

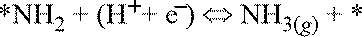

After the addition of 3(H⁺ + e⁻) one ammonia molecule is formed and the second one is formed after the addition of 6(H⁺ + e⁻).

The different parts or components can be provided in separate containers, or they can be provided in a single container. An advantage of the present invention is that the process and system can be suitably operated using aqueous electrolytes, such as preferably aqueous solutions with dissolved electrolytes (salts). Thus, in preferred embodiments of the process and system, the electrolytic cell comprises one or more aqueous electrolytic solutions, in one or more cell compartments. Electrolyte solutions may comprise any of various typical inorganic or organic salts such as but not limited to soluble salts of chloride, nitrate, chlorate, bromide, etc. e.g. sodium chloride, potassium chloride, calcium chloride, ammonium chloride, and other suitable salts. The aqueous electrolyte solutions may also comprise any one, or a combination of, alkali or alkaline earth metal hydroxides, such as sodium hydroxide, potassium hydroxide, lithium hydroxide, calcium hydroxide, rubidium hydroxide and cesiumcaesium hydroxide. The aqueous electrolyte solution can also further, or alternatively, comprise one or more organic or inorganic acids. Inorganic acids can include mineral acids that include but are not limited to, hydrochloric acid, nitric acid, phosphoric acid, sulphuric acid, boric acid, hydrofluoric acid, hydrobromic acid, tetrafluoro-acetic-acid, acetic-acid and perchloric acid. Accordingly, the aqueous solution can be a neutral, an alkaline or an acidic solution. In some embodiments, the aqueous solution is an acidic solution. The electrolyte can also be a molten salt, for example a sodium chloride salt. In some embodiments the electrolytic cell comprises an electrolytic solution comprising a organic protic or aprotic solvent, or a miscible mixture thereof, preferably a water-miscible organic solvent, such as for example but not limited to ethanol, ethylene glycol, butanediol, glycerol, diethanolamine, dimethoxyethane, 1,4-dioxane, and mixtures thererof. The electrolytic solution can be a solution comprising water and one or more water-miscible organic solvent such as but not limited one or more of the above mentioned solvents.

In general terms, the catalyst on the electrode surface should ideally have the following characteristics: It should (a) be chemically stable, it should (b) not become oxidized or otherwise consumed during the electrolytic process, it should facilitate the formation of ammonia, and (d) use of the catalyst should lead to the production of minimal amount of hydrogen gas. As will be further described, the catalyst oxides according to the invention fulfill these characteristics.

An advantage of the present invention is that the process can be suitably operated using aqueous electrolytes, such as preferably aqueous solutions with dissolved electrolytes (salts). Thus, in preferred embodiments of the process and system, the electrolytic cell comprises one or more aqueous electrolytic solutions, in one or more cell compartments. Aqueous electrolyte solutions may comprise any of various typical inorganic or organic salts such as but limited to soluble salts of chloride, nitrate, chlorate bromide, etc. e.g. sodium chloride, potassium chloride, calcium chloride, ammonium chloride, and other suitable salts. The aqueous electrolyte solutions may also comprise any one, or a combination of, alkali or alkaline earth metal oxides, such as sodium hydroxide, potassium hydroxide, lithium hydroxide, calcium hydroxide, rubidium hydroxide and cesium hydroxide. The aqueous electrolyte solution can also further, or alternatively, comprise one or more organic or inorganic acids. Inorganic acids can include mineral acids that include but are not limited to, hydrochloric acid, nitric acid, phosphoric acid, sulphuric acid, boric acid, hydrofluoric acid, hydrobromic acid, and perchloric acid.

As appears from herein, the essential feature of the present invention concerns the composition and structure of the cathode electrode. Transition metal oxides have a wide variety of surface structures which affect the surface energy of these compounds and influence their chemical properties. The relative acidity and basicity of the atoms present on the surface of metal oxides are also affected by the coordination of the metal cation and oxygen anion, which alter the catalytic properties of these compounds.

In certain embodiments, the transition metal oxide catalyst on the cathode electrode surface is selected from one or more of the following: Titanium oxide, Chromium oxide, Manganese oxide, Niobium oxide, Tantalum oxide, Ruthenium oxide, Rhodium oxide, Platinum oxide, Osmium oxide, Rhenium oxide and Iridium oxide. Preferably the catalyst comprises one or more of Rhenium oxide, Tantalum oxide and Niobium oxide.

Depending on the substance composition of the catalyst, a suitable surface crystal structure may be preferred. Various different crystal structures exist for transition metal oxides and different structures can be obtained at different growth conditions. It is within scope of the skilled person to select appropriate surface crystal structures.

It may be preferable that the catalyst copmrise at least one surface having a rutile structure. Other crystal structures known in the art (e.g., rocksalt structure, zincblende structure, anatase structure, perovskite structure) are also possible (see., e.g., International Tables for Crystallography; http://it.iucr.org).

Several different surface facets may exist for a given crystal structure (polycrystalline surfaces). The (110) facet of rutile exhibits the lowest surface free energy and is therefore in general thermodynamically most stable. Accordingly, in some embodiments, the transition metal oxides can be of rutile structure with a (110) faced providing the catalytic surface. Alternatively, the (100) and/or the (111) facets of the rocksalt structure can be chosen.

Thus, in some embodiments, the catalyst surface is a transition metal rutile surface. The surface can have any suitable facet, including but not limited to the (110) facet. In some embodiments, the surface facet comprises, or consists of, the (110) facet of a transition metal oxide selected from the group consisting of Titanium oxide, Chromium oxide, Manganese oxide, Niobium oxide, Tantalum oxide, Ruthenium oxide, Rhodium oxide, Platinum oxide, Osmium oxide, Rhenium oxide and Iridium oxide.

In some preferred embodiments, the catalyst comprises a the (110) facet of the rutile structure of one or more oxide selected from Rhenium oxide, Tantalum oxide and Niobium oxide.

A rutile metal oxide surface having a (110) facet contains metal atoms of two different coordination environments, where rows of sixfold coordinated metal atoms alternate with rows of fivefold coordinated metal atoms along the [001] direction. Whereas the sixfold coordinated metal atoms have approximately the same geometry as bulk, the fivefold coordinated metal atoms have an unsaturated bond perpendicular to the surface. Thus two distinct surface sites are found, coordinatively unsaturated sites (cus-sites) on top of the 5-fold coordinated metal atoms and bridging sites (br-sites) between two sixfold coordinated metal atoms. It has been found that the br-sites generally bind adsorbates stronger than the cus-sites. On the stoichiometric (110) surface, the br-sites are occupied by oxygen, while the cus-sites are vacant. The (110) surface can be referred to as oxygen terminated (O-term). The bridging oxygen atoms are under-coordinated and can be reduced on the surface:

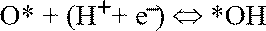

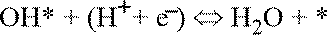

leaving the br-sites vacant. These vacant br-sites can then get further protonated:

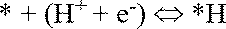

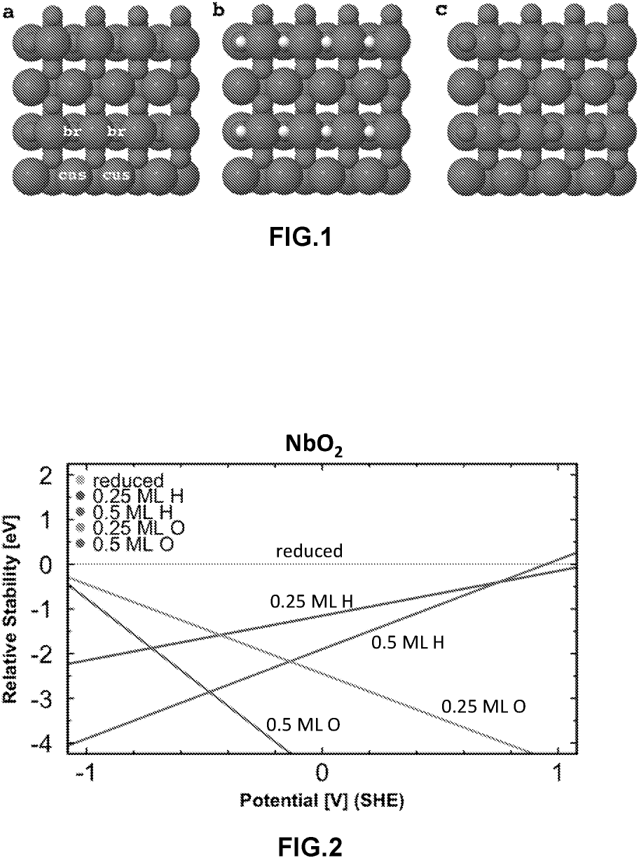

As a consequence, the 110 surface may be reduced, leaving bridging sites between sixfold coordinated metal atoms vacant. The bridging sites may also be occupied, partially or completely, by other atoms such as oxygen or hydrogen atoms, as illustrated by FIG. 1 herein.

It has been found that the catalytic activity of the (110) surface may also be dependent on the occupancy of the br-sites. Thus, it can be favorable thermodynamically to reduce the bridging oxygen atoms on transition metal oxides to H₂O and further cover the br-sites with hydrogen atoms.

Accordingly, in some embodiments, bridging sites between sixfold coordinated transition metal atoms on transition metal oxide surfaces are covered by hydrogen atoms.

As will be apparent to the skilled person, the catalyst according to the invention can comprise a single transition metal oxide. The catalyst can also comprise, or consist of, a mixture of two or more such oxides. Such mixed oxides can comprise a single structure, for example a rutile structure. The mixed metal oxides can also comprise a mixture of oxides that are of different crystal structures and/or oxides with different catalytic facets. Accordingly, such mixed oxides can further comprise a single, or a mixture of, facets. Mixed oxide catalysts can be grown or manufactured separately and then assembled into mixed catalysts comprising the different metal oxides, wherein the oxides in the mixture have the same or different crystal structures.

As described in more detail herein, running a current through the electrolytic cell leads to a chemical reaction in which nitrogen reacts with protons to form ammonia. The running of current is achieved by applying a voltage to the cell. The invention makes possible electrolytic production of ammonia at a low electrode potential, which is beneficial in terms of energy efficiency and equipment demands.

Without intending to be bound by theory, it is believed that the oxide catalysts are capable of shifting the bottleneck of ammonia synthesis from N₂ cleavage to the subsequent formation of nitrogen-hydrogen species (*NH,*NH₂, or *NH₃) due to which simpler but yet higher rate of ammonia formation is anticipated.

In certain useful embodiments of the invention, ammonia can be formed at an electrode potential at less than about -1.1 V, less than about -1.0 V, less than about -0.9 V, less than about -0.8 V, less than about -0.7 V, less than about -0.6 V, less than about 0.5 V or less than about -0.4 V. In some embodiments, ammonia can be formed at electrode potential in the range of about -0.2 V to about -1.0 V, such as in the range of about -0.3 V to about -0.8 V, such as in the range of about -0.4 V to about -1.0 V, or in the range of about -0.5 V to about -1.0 V. The upper limit of the range can be about -0.6 V, about -0.7 V, about -0.8 V, about -1.0 V, or about -1.1 V. The lower limit of the range can be about -0.2 V, about -0.3 V, about -0.4 V, about -0.5 V or about -0.6 V.

In some embodiments, ammonia can be formed using an Niobium oxide catalyst at an electrode potential that is in the range of about -0.4 V to about -0.5 V. In some embodiments, ammonia can be formed using an Rhenium oxide catalyst at an electrode potential of about -0.8 V to about -0.9 V. In some embodiments, ammonia can be formed using an Tantalum oxide catalyst at an electrode potential of about -1.0 V to about -1.1 V.

An advantage of the present invention is the efficiency of NH₃ formation over H₂ formation, which has been a challenge in prior art investigations and trials. In certain embodiments of the invention, less than about 50% moles H₂ are formed compared to moles NH₃ formed, and preferably less than about 40% moles H₂, less than about 30% moles H₂, less than about 20% moles H₂, less than about 10% moles H₂, less than about 5% moles H₂, less than about 2% moles H₂, or less than about 1% moles H₂.

The system of the invention is suitably designed in order to accommodate one or more of the above process features. It is an advantage of the invention that the system can be made small, robust and cheaply, such as for using locally for production of fertilizer close to the intended site of use.

Ammonia can be used as such as fertilizer, by injecting into soil as gas, although this requires investment by farmers in pressurized storage tanks and injection machinery. Ammonia can also be used to form urea, typically by reacting with carbon dioxide. Ammonia can be reacted to form nitric acid, which in turn is readily reacted to form ammonium nitrate. Accordingly, systems and processes of the present invention can be readily combined with present solutions for reacting the produced ammonia to other desired products such as but not limited to the above mentioned.

NOₓ and SOₓ are generic terms for mono-nitrogen and mono-sulfur axoides, such as NO, NO₂, SO, SO₂ and SO₃. These gases are produced during combustion, especially at high temperatures. In areas of high motor vehicle traffic, the amount of these pollutants can be significant.

Accordingly, a useful aspect of the invention relates to a system for removing NOₓ and/or SOₓ from a stream of gas, by reacting the stream of gas with ammonia that is generated in situ in the stream, or in a system that can be fluidly connected to the stream of gas. The system can comprise a system for generating ammonia as described herein, in particular a system that comprises an electrolytic cell containing a transition metal oxide catalyst as described herein. In this context, in situ should be understood as meaning that the ammonia is generated within the system, for example within the gas stream, or in a compartment within the system that is fluidly connected to the gas stream. The ammonia thus generated, when in contact with the stream of gas, will react with NOₓ and/or SOₓ in the stream of gas so as to convert these toxic species to other molecular species, such as N₂, H₂O and (NH₄)2SO₄. In some embodiments, the system can be for use in an automobile engine exhaust or in other engines, where ammonia can be generated in situ by a process according to the present invention, and which is then used to reduce SOₓ and/or NOₓ exhaust gases from the engine. Such system can suitably use electric current produced by conversion from the car engine. Thus, by using electric current from a car engine, ammonia can be generated in situ, and the ammonia thus generated can be allowed to react with SOx and/or NOx from the gas exhaust of the automobile. The ammonia can be generated in the automobile, and subsequently fed into the car exhaust. The ammonia can also be generated in situ within the automobile exhaust system. Thereby, NOₓ and/or SOₓ are removed from the car exhaust, reducing the amount of pollutants in the exhaust.

Embodiments of the invention include the following non-limiting clauses:
1. A process for producing ammonia comprising: feeding N₂ to an electrolytic cell that comprises at least one source of protons;
   allowing the N₂ to come into contact with a cathode electrode surface in the electrolytic cell, wherein the cathode electrode surface comprises a catalyst surface comprising at least one transition metal oxide;and
   running a current through said electrolytic cell, whereby nitrogen reacts with protons to form ammonia.
2. The process of clause 1, wherein the catalyst comprises one or more transition metal oxide selected from the group consisting of Titanium oxide, Chromium oxide, Manganese oxide, Niobium oxide, Tantalum oxide, Ruthenium oxide, Rhodium oxide, Platinum oxide, Osmium oxide, Rhenium oxide and Iridium oxide.
3. The process of clause 1 or clause 2, wherein the catalyst comprises one or more oxide selected from the group consisting of Rhenium oxide, Tantalum oxide and Niobium oxide.
4. The process of any one of the preceding clauses, wherein the catalyst surface comprises at least one surface having a rutile structure.
5. The process of any one of the preceding clauses, wherein the catalyst surface comprises at least one surface having a (110) facet.
6. The process of any of the preceding clauses, wherein ammonia is formed in the electrolytic cell at an electrode potential at less than about -1.0 V, more preferably less than about -0.8 V and even more preferably less than about -0.5 V.
7. The process of any one of the preceding clauses, wherein the catalyst comprises Niobium oxide, and wherein ammonia is formed in the electrolytic cell at an electrode potential at less than about -0.5 V.
8. The process of any one of the preceding clauses, wherein the catalyst comprises Rhenium oxide, and wherein ammonia is formed in the electrolytic cell at an electrode potential at less than about -0.9 V.
9. The process of any one of the preceding clauses, wherein the catalyst comprises Tantalum oxide, and wherein ammonia is formed in the electrolytic cell at an electrode potential at less than about -1.0 V.
10. The process of any of the preceding clauses, wherein less than 50% moles H₂ are formed compared to moles NH₃ formed, and preferably less than 20% and even more preferably less than 10%.
11. The process of any of the preceding clauses, wherein said electrolytic cell comprises one or more aqueous electrolytic solution.
12. The process of any of the preceding clauses, wherein the source of protons in the formation of ammonia is from water splitting in the electrode or H₂ oxidation reaction in the anode.
13. A system for generating ammonia, the system comprising at least one electrochemical cell, the at least one electrochemical cell comprising at least one cathode electrode having a catalytic surface, wherein the catalytic surface is charged with at least one catalyst comprising one or more transition metal oxide.
14. The system of clause 13, wherein the at least one transition metal oxide is selected from the group consisting of Titanium oxide, Chromium oxide, Manganese oxide, Niobium oxide, Tantalum oxide, Ruthenium oxide, Rhodium oxide, Platinum oxide, Osmium oxide, Rhenium oxide and Iridium oxide.
15. The system of clause 13 or 14, wherein the at least one transition metal oxide is selected from the group consisting of Rhenium oxide, Tantalum oxide and Niobium oxide.
16. The system of any one of the preceding clauses 14-15, wherein the catalyst surface comprises at least one surface having a rutile structure.
17. The system of any one of the preceding clauses 14-16, wherein the catalyst surface comprises at least one surface having a (110) facet.
18. The system of any one of the clauses 14 to 17, wherein said electrolytic cell further comprises one or more electrolytic solution.
19. The system of clause 18, wherein the electrolytic solution is an acidic aqueous solution.

The invention will now be illustrated by the following non-limiting examples that further describe particular advantages and embodiments of the present invention.

### Example 1

The zero-point energy correction and entropy difference between the adsorbed species and the gas molecule, are calculated for all reaction intermediates within a harmonic approximation. These values are given in Table 1.

TABLE 1

Zero-point energy and entropy contributions to the free energy of gas phase and adsorbed molecules at 300 K for rutile oxides (in eV).

| Rutiles (110) reduced surface | TS | ZPE |
|---|---|---|
| NH₃ | 0.74 | 0.89 |
| H₂ | 0.41 | 0.27 |
| N₂ | 0.60 | 0.15 |
| *H | 0.01 | 0.19 |
| *NNH | 0.15 | 0.48 |
| *NHNH | 0.12 | 0.81 |
| *NNH2 | 0.10 | 0.86 |
| *NHNH₂ | 0.12 | 1.18 |
| *NH₂NH₂ | 0.15 | 1.48 |
| *NHNH₃ | 0.15 | 1.47 |
| *N | 0.02 | 0.11 |
| *NH | 0.05 | 0.36 |
| *NH₂ | 0.07 | 0.70 |
| *NH₃ | 0.16 | 1.00 |
| Rutiles (110) O-term/ H-term surfaces | TS | ZPE |
| *H | 0.01 | 0.19 |
| *NNH | 0.09 | 0.52 |
| *NHNH | 0.10 | 0.82 |
| *NNH₂ | 0.11 | 0.82 |
| *NHNH₂ | 0.14 | 1.15 |
| *NH₂NH₂ | 0.17 | 1.52 |
| *NHNH₃ | 0.17 | 1.49 |
| *N | 0.06 | 0.08 |
| *NH | 0.07 | 0.37 |
| *NH₂ | 0.11 | 0.66 |
| *NH₃ | 0.15 | 1.02 |

The values for gas phase molecules are taken from Weast (Handbook of Chemistry and Physics, 49th edn., p. D109, The Chemical Rubber Company, Cleveland 1968-1969) and Atkins (Physical Chemistry, Oxford University Press, 6th edn., 1998), and the values for adsorbed molecules are obtained from DFT calculations of vibrational normal modes.

### Example 2

### Introduction

Various electrolytes and electrode materials have been tried in order to alleviate the thermodynamic requirements and optimize the ammonia formation rate using heterogeneous catalysis. (AMarch 2011; Denvir 2008 (US7314544 B2);Ouzoounidou 2007; Pappenfus 2009; AMarch 2011;Song 2004) Electrolytic cells based on solid-state electrolytes and polymer electrolyte membranes (PEM) have been the subjects of much of this research as the setup simplifies the separation of the hydrogen feed gas and the produced ammonia. The highest rate of ammonia formation reported with Nafion membrane is 1.13 x 10⁻⁸ mol s⁻¹ cm⁻² with faradaic efficiency of around 90%, where wet H₂ was used as the feed gas. (Xu 2009) Using air and water as feed gases is an exciting possibility, however, the highest rate of ammonia formation obtained in that way was much lower, 1.14 x 10⁻⁹ mol s⁻¹ cm⁻². (Lan 2013) Only 1% CE was obtained, requiring an overpotential of -1.6 V. Although promising, these results are still far from the production rates nearing that of commercial viability (4.3-8.7 x 10⁻⁷ mol s⁻¹ cm⁻ ²). (Giddey, Badwal, 2013)

The search for a new route towards ammonia synthesis has up until now been led by experimentalists. Recently however, electrocatalytic N₂ reduction has been the subject of theoretical studies, where materials that favor N₂ reduction and suppress hydrogen evolution are suggested by the help of density functional theory (DFT) calculations.(Skúlason 2012, Abghoui 2015 enabling, 2016 ACS Catalysis, 2016 Catalysis Today, 2016 Catalysis Today, 2017 Phys. Chem. C, J Howalt 2013, J Howalt 2014, Hargreaves 2014, Zelinapour-Yazdi 2016) The use of computational methods makes it possible to scan through large groups of potential catalysts without having to produce them in the laboratory, saving both time and money. In 2012 Skúlason et al. did a detailed DFT analysis on the catalytic activity of both flat and stepped pure transition metal surfaces where they identified trends and calculated the free energy profile for nitrogen reduction. The so-called volcano plots are useful when estimating trends in catalytic reactivity and Skúlason et al. found that the early transition metals were more active towards N₂ reduction than the later transition metals, as well as being less prone to evolving hydrogen. (Skúlason 2012) Abghoui et al. did a similar study on transition metal mono nitrides and found that early transition metal nitrides were promising candidates towards N₂ reduction, where ZrN and VN were predicted to form ammonia at potentials of -0.76 V and -0.51 V vs. SHE, respectively. (2015 PCCP, 2015 Proceedia computer science, 2016 ACS Catalysis). Later they also suggested that NbN and CrN could behave in a similar fashion. (Abghoui Skulason,2017,MVK). Further studies have given promising results where the (110) facets of the zincblende structure of RuN was reported to catalyze ammonia formation at very small onset potential of around -0.23 V vs. SHE. (Abghoui 2017) The comparison of the Mars-van Krevelen mechanism (MvK) with the conventional associative and dissociative mechanisms revealed that the MvK should be a more favorable reaction mechanism on the surface of these nitrides. (Abghoui and Skulason 2017)

In the present study, transition metal oxides in the rutile structure are investigated as possible candidates for catalyzing ammonia formation electrochemically at ambient conditions. DFT calculations are used to construct a stability diagram for each metal oxide where stability of the (110) facet covered with different adsorbed species is calculated as a function of potential, and the most stable facet at each potential is identified. Next we study the thermodynamics of the cathode reaction and construct free energy diagrams for the electrochemical protonation of the adsorbed nitrogen species. The energetics between adsorption of proton and N₂H species were investigated for all the potential catalysts to see the trend toward N₂ reduction compared to the competing hydrogen evolution reaction (HER). We then estimate the onset potentials required for ammonia formation on the surface of these oxides. The effect of external potential is included by using the computational standard hydrogen electrode (SHE) (Norskov, Jonsson 2004) and the lowest onset potential required to reduce N₂ to ammonia is estimated for each metal oxide. Finally, a volcano diagram is obtained where the catalytic activity of the different oxides is plotted using the binding energy of N₂H as a common descriptor. (Rossmeisl 2007, Skúlason 2012)

### Methodology

DFT calculations: In the present study the (110) facet of eleven transition metal oxides naturally occurring in the rutile structure is considered with focus on electrochemical ammonia formation, as the (110) surface is the most stable of the low-index facetss of the rutile structure. The oxides stable in the rutile structure at ambient conditions are: TiO₂, NbO₂, TaO₂, ReO₂, IrO₂, OsO₂, CrO₂, MnO₂, RuO₂, RhO₂ and PtO₂. (Harold Kung) The oxide surfaces are modelled by 48 atoms in four layers, each layer consisting of 4 metal atoms and 8 oxygen atoms. The bottom two layers are kept fixed whereas the upper two layers and the adsorbed species are allowed to fully relax. Boundary conditions are periodic in the x and y directions and the surfaces are separated by 12 Å of vacuum in the z direction. The structural optimization is considered converged when the forces in any direction on all moveable atoms are less than 0.01 eV/Å. The RPBE lattice constants were optimized for each oxide and spin-polarization was accounted for. The RPBE lattice constants optimized for the oxides in this study are: TiO₂: a=4.65 Å, c=2.98 Å; NbO₂: a=5.11 Å, c=3.00 Å; TaO₂: a=4.98 Å, c=3.02 Å; ReO₂: a=4.77 Å, c=3.14 Å; lrO₂: a=4.58 Å, c=3.13 Å; OsO₂: a=4.58 Å, c=3.18 Å; CrO₂: a=4.50 Å, c=2.96 Å; MnO₂: a=4.86 Å, c=2.85 Å; RuO₂: a=4.58 Å, c=3.2 Å; RhO₂: a=4.55 Å, c=3.06 Å and PtO₂: a=4.65 Å, c=3.19 Å.

The calculations are performed with DFT using the RPBE exchange correlation functional. A plane wave basis set with an energy cutoff of 350 eV is used to represent the valence electrons with a PAW representation of the core electrons as implemented in the VASP code (VASP1-VASP4). The self-consistent electron density is determined by iterative diagonalization of the Kohn-Sham Hamiltonian, with the occupation of the Kohn-Sham states being smeared according to a Fermi-Dirac distribution with a smearing parameter of k_{B}T = 0.1 eV. A 4 x 4 x 1 Monkhorst-Pack k-point sampling is used for all the surfaces and maximum symmetry is applied to reduce the number of k-points in the calculations.

Electrochemical reactions and modelling: The source of protons in the reaction could either be water splitting or H₂ oxidation reaction in the anode. In order to link our absolute potential to the SHE, we refer to H₂ here only as a convenient source of protons and electrons.

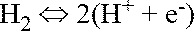

where the protons are solvated in the electrolyte and the electrons are transferred to the cathode through a wire. The overall reaction for N₂ reduction is

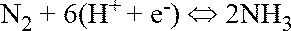

The surface is hydrogenated by adding one hydrogen atom at a time, representing a proton from the solution and an electron from the electrode surface. The reaction mechanism studied, the associative one, is shown in the equations below where an asterisk denotes a surface site:

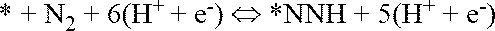

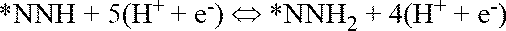

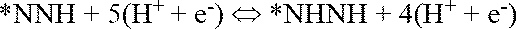

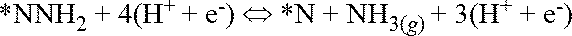

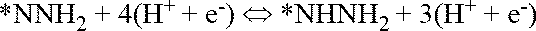

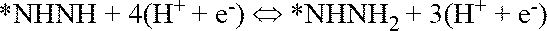

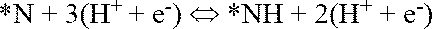

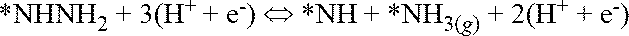

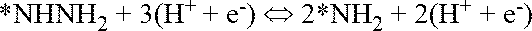

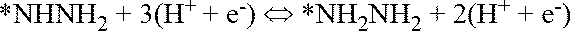

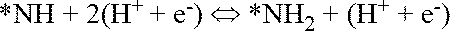

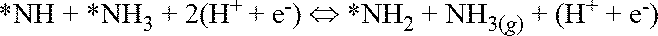

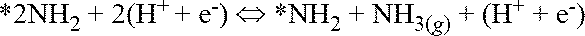

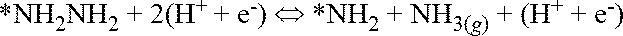

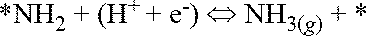

The first ammonia molecule is formed after the addition of three to five protons, depending on the favored reaction pathway. The second ammonia is then formed after the addition of six protons. The free energy of N₂H adsorption is compared to that of proton adsorption, to probe whether the surface is selective towards either ammonia formation or hydrogen evolution.

As a first approximation, it is assumed that activation barriers between stable minima are low or that they follow a Brønsted-Evans-Polanyi relationship and can therefor be neglected during the electrochemical reactions in the context of the present invention. The free energy of each elementary step is estimated at pH=0 and T=298 K according to:

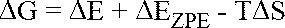

where ΔE is the energy calculated using DFT. ΔE_{ZPE} and ΔS are the differences in zero point energy and entropy, respectively, between the adsorbed species and the gas phase molecules. They are calculated within a harmonic approximation and the values are given in the ESI. The effect of an applies bias U, is included for all electrochemical reaction steps by shifting the free energy for the reaction involving n electrons by -neU so the free energy of each elementary step is given by:

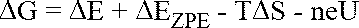

Explicit inclusion of water in the simulations would greatly increase the computational effort and has therefore not been included in the present study. The presence of water is known to stabilize some species via hydrogen bonding. For instance, *NH₂ is expected to be slightly more stable in the vicinity of water whereas *N will not be affected by the water layer. Previous publications have estimated the stabilization effects of water to be smaller than 0.1 eV per hydrogen bond. (Montoya 2015) Therefore, we estimate that the inclusion of hydrogen bonding would change the onset potentials calculated in this study by less than 0.1 eV, a correction that has not been included here.

### Results and Discussion

Stability: The rutile (110) surface contains metal atoms of two different coordination environments, see FIG. 1. Rows of sixfold coordinated metal atoms alternate with rows of fivefold coordinated metal atoms along the [001] direction. Whereas the sixfold coordinated metal atoms have approximately the same geometry as the bulk, the fivefold coordinated metal atoms have an unsaturated bond perpendicular to the surface. (Morgan 2007) Thus two distinct surface sites are found, coordinatively unsaturated sites (cus-sites) on top of the 5-fold coordinated metal atoms and bridging sites (br-sites) between two sixfold coordinated metal atoms. We find that the br-sites generally bind adsorbates stronger than the cus-sites, and the catalytic activity of the surface is dependent on the occupancy of the br-sites. Therefore, a systematic study of different coverages of oxygen and hydrogen on the br-sites is carried out for each rutile oxide and the relative stability of the (110) facet with the different coverages is presented in stability diagrams, see FIG. 2 as an example (but all the others are shown in ESI). On the stoichiometric (110) surface, the br-sites are occupied by oxygen, while the cus-sites are vacant. We refer to the stoichiometric (110) surface as oxygen terminated (O-term), see FIG. 1c. The bridging oxygen atoms of the O-term surface are under-coordinated and can be reduced from the surface in the experiments and under operational conditions. To calculate the free energy of reduction of the O-term surface, we follow a methodology developed by Nørskov et al., where the reduction of the surface takes place through the exchange of water and protons with the electrolyte:

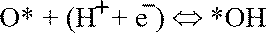

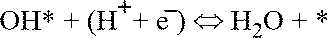

leaving the br-sites vacant. We refer to that surface as the reduced surface, see FIG. 1a. The vacant br-sites can then get further protonated:

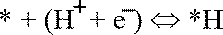

We refer to that surface as hydrogen terminated (H-term), see FIG. 1b. We also look at the surface configuration where half the br-sites are covered with either hydrogen or oxygen and half the sites are vacant. These surfaces are referred to as the 0.25 monolayer (ML) surfaces.

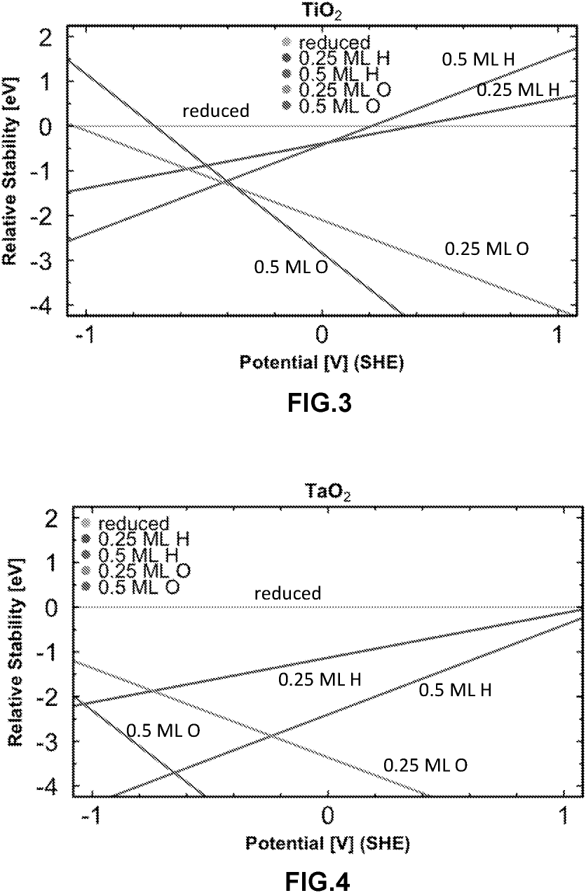

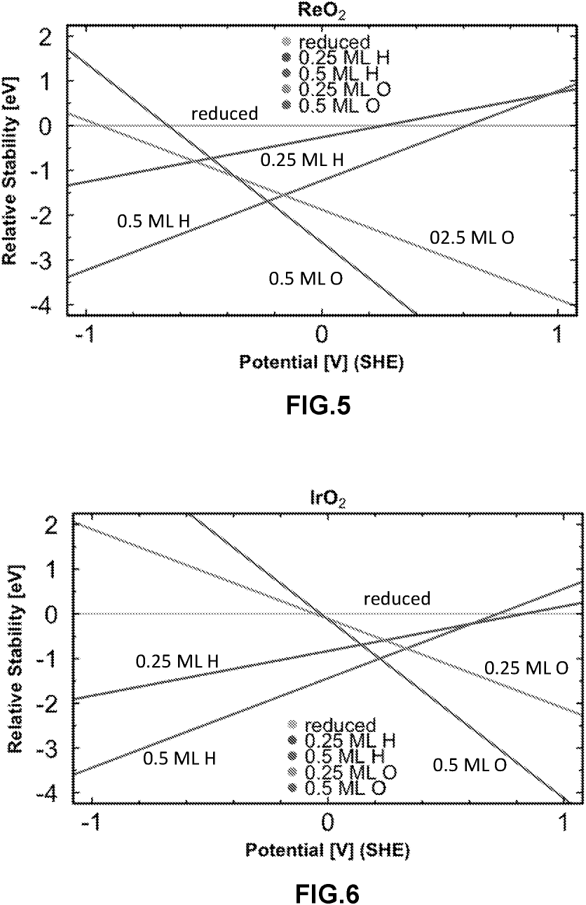

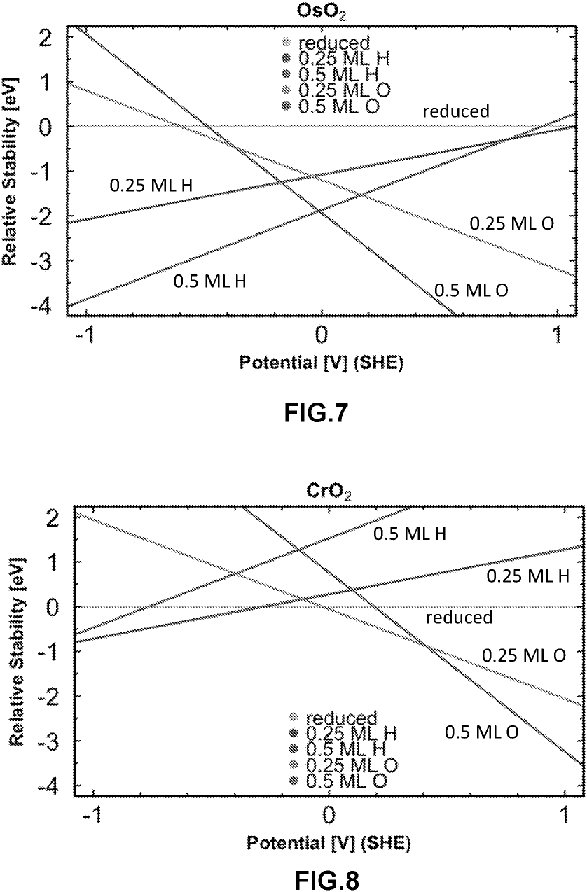

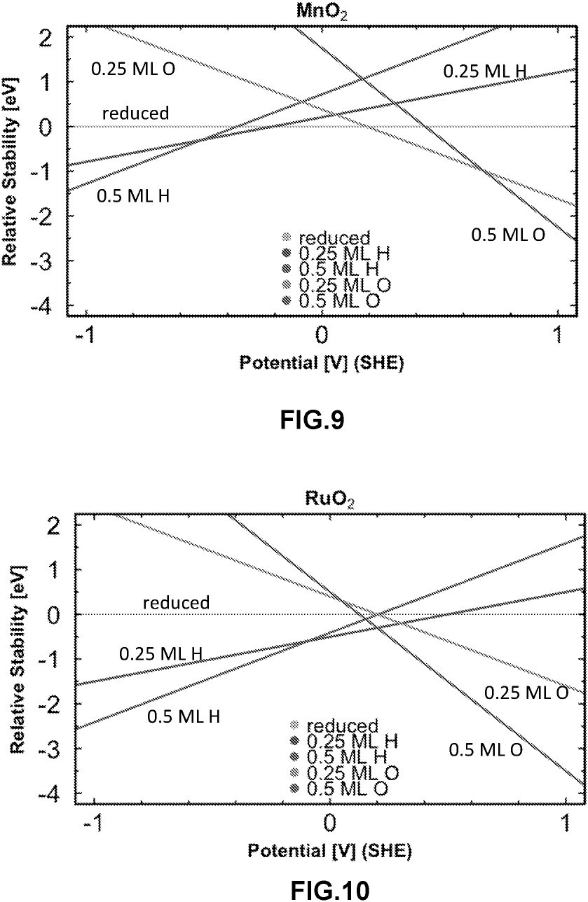

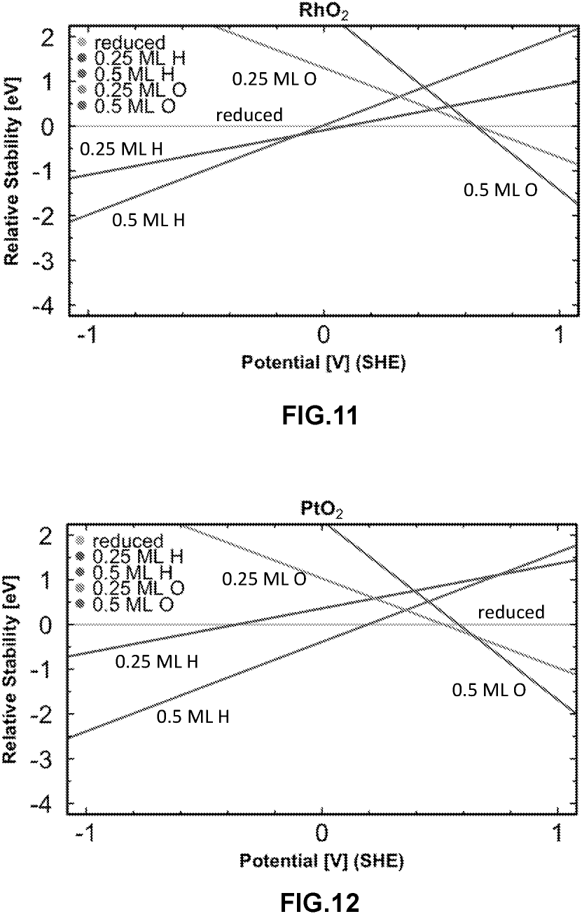

FIG. 2 shows an example of a stability diagram constructed for NbO₂. The x-axis represents the free energy of the reduced surface, which is used as a reference that the other surfaces are normalized towards. The stability plot in FIG. 2 shows that, at potentials below -0.5 V vs. SHE, it is thermodynamically favorable to reduce the bridging oxygen atoms on NbO₂ to H₂O and further protonate the br-sites to 0.5 ML H coverage. The stability diagrams for the other metals are shown in FIGS. 3-12. For all the oxides the 0.25 ML H or O coverages are not favored at any relevant potential, and are therefore left out of all further calculations. It should be noted that this analysis is based on thermodynamics and does not include activation energies.

Catalytic activity: The catalytic activity of all the rutile oxides towards electrochemical ammonia formation is calculated by the use of DFT. For each rutile the free energy landscape is calculated for the three different surfaces, the reduced, the H-term and the O-term surface. The free energy of each intermediate is found with equation (10), referenced to N₂ and H₂ in the gas phase. As seen by the stability diagrams, the 0.25 ML surfaces are not favored on any significant potential range, and are therefore left out of all further calculations.

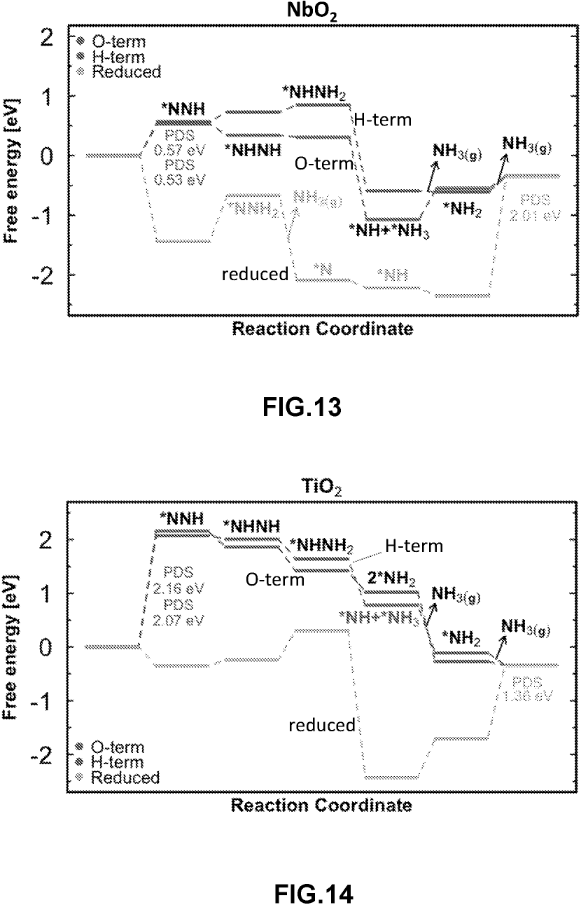

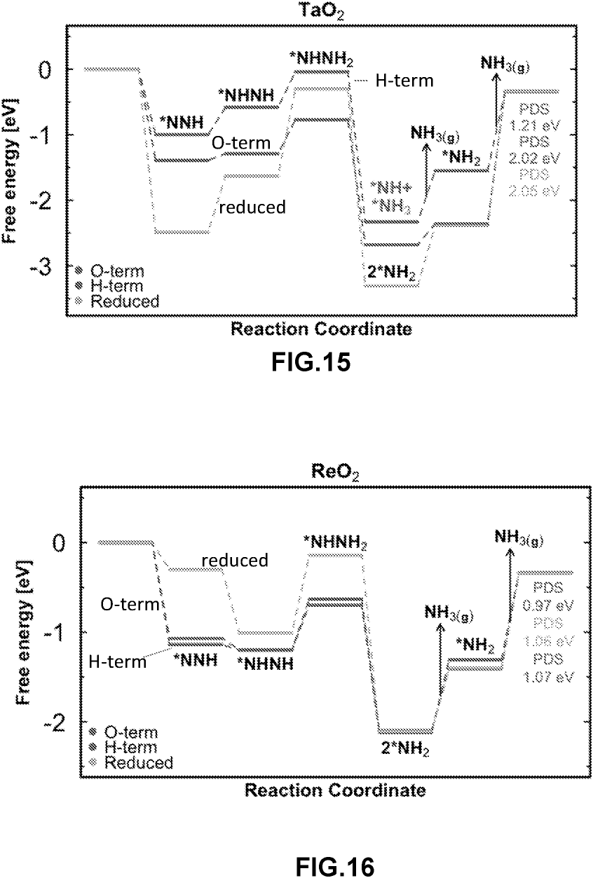

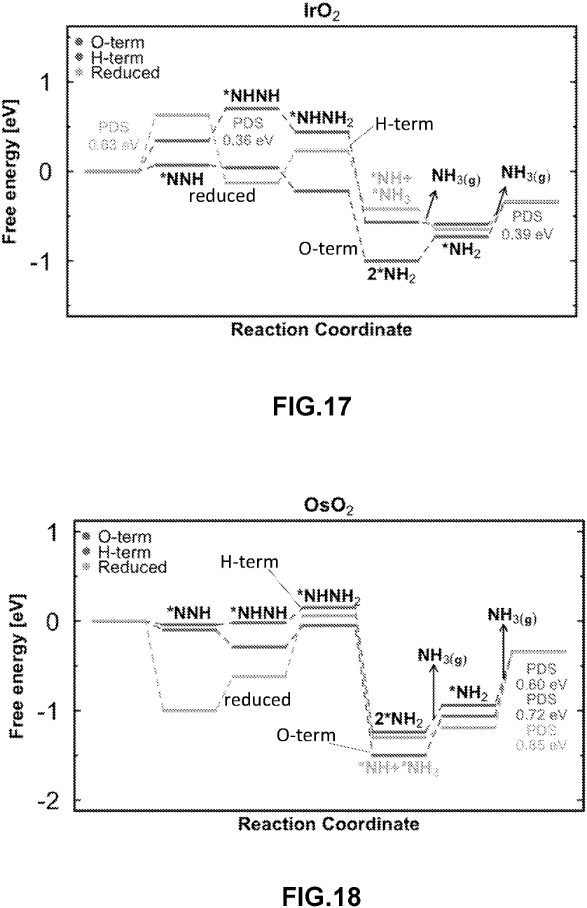

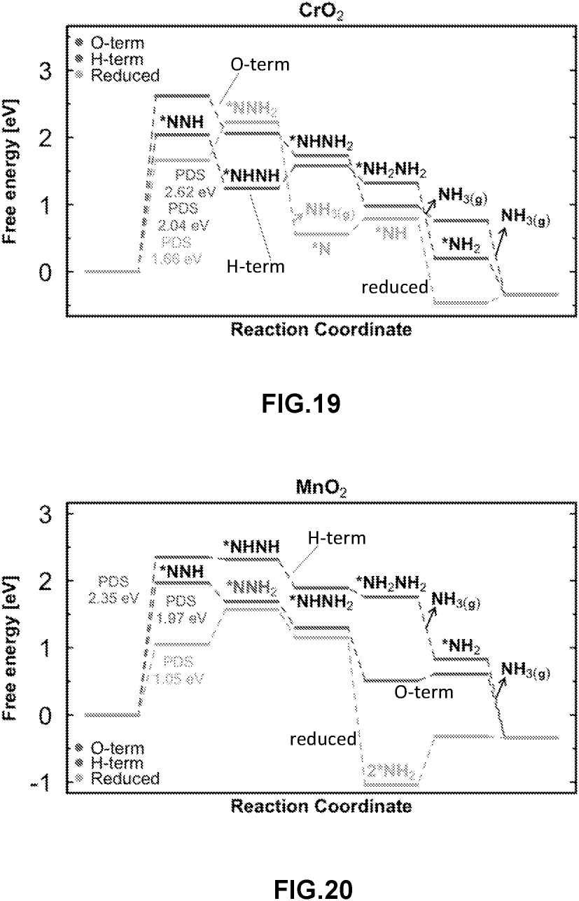

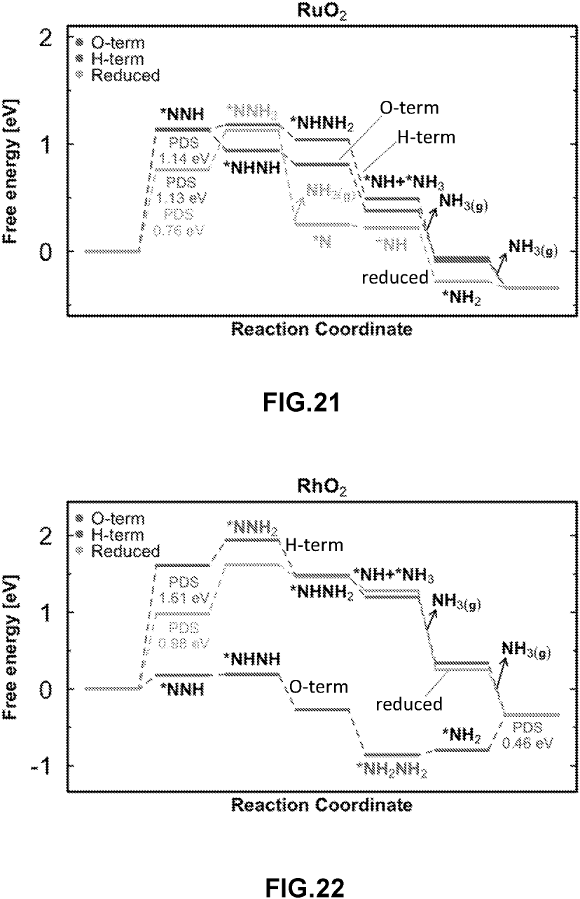

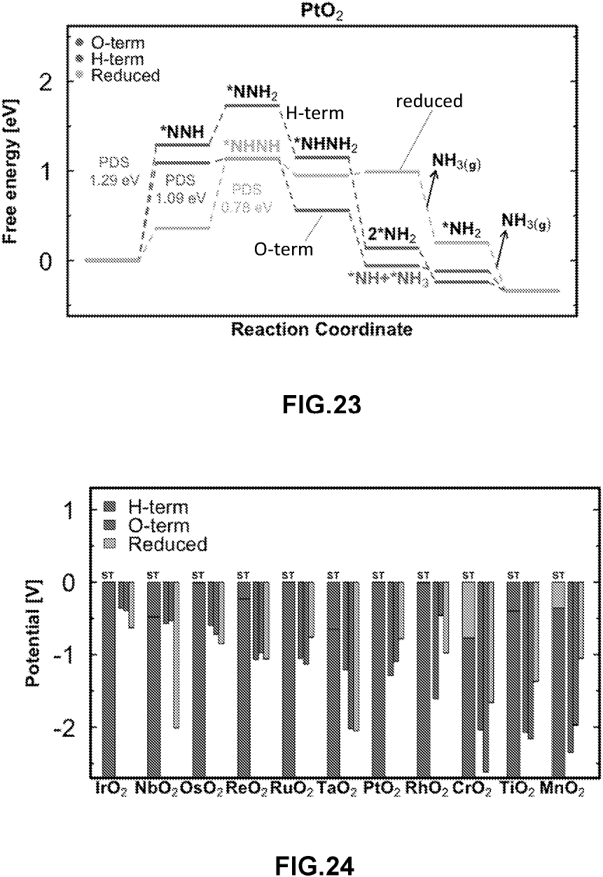

FIG. 13 shows the free energy landscape of ammonia formation on NbO₂, identifying the corresponding potential-determining step (PDS) for each surface, i.e. the step with the highest change in free energy, which determines the onset potential required for all reaction steps to be downhill in free energy. We identify this step as a measure of the oxide’s activity towards ammonia formation. The free energy diagrams for the other rutile oxides are provided in FIGS. 14-23. It is seen in FIG. 13 that the free energy change of the PDS predicted for ammonia formation on the O-term and the reduced surface is -0.53 eV and -2.01 eV, respectively.

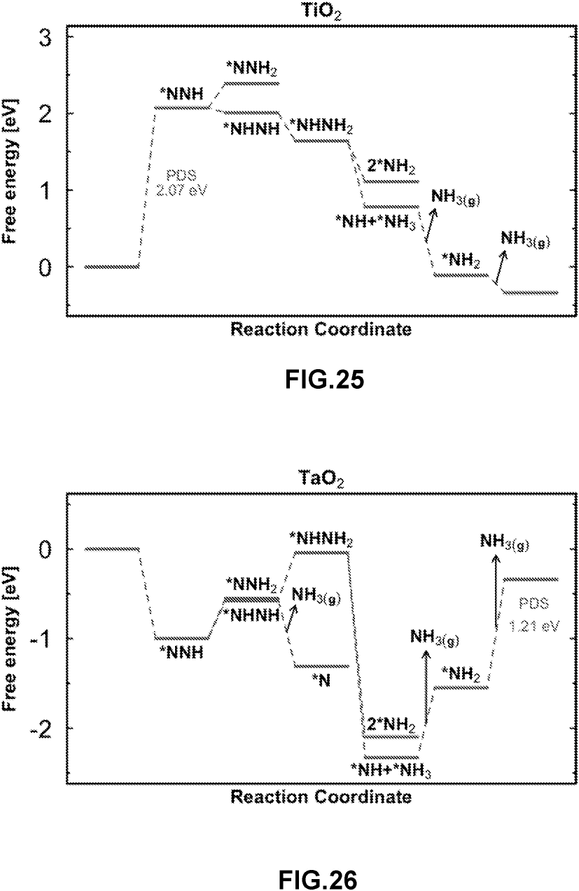

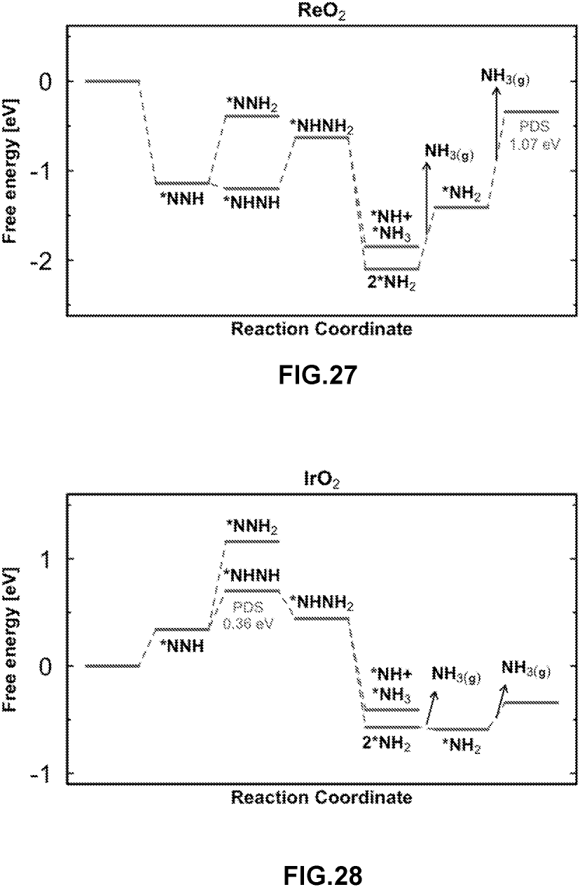

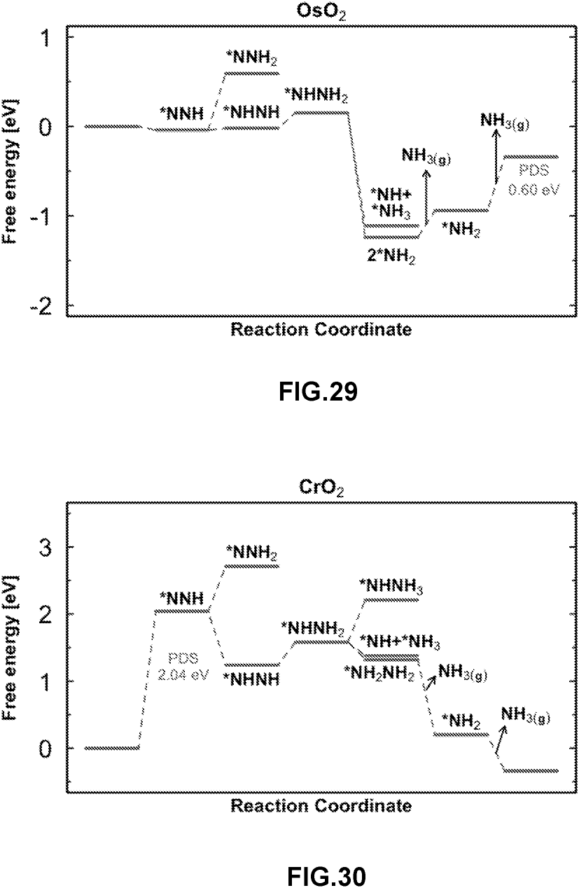

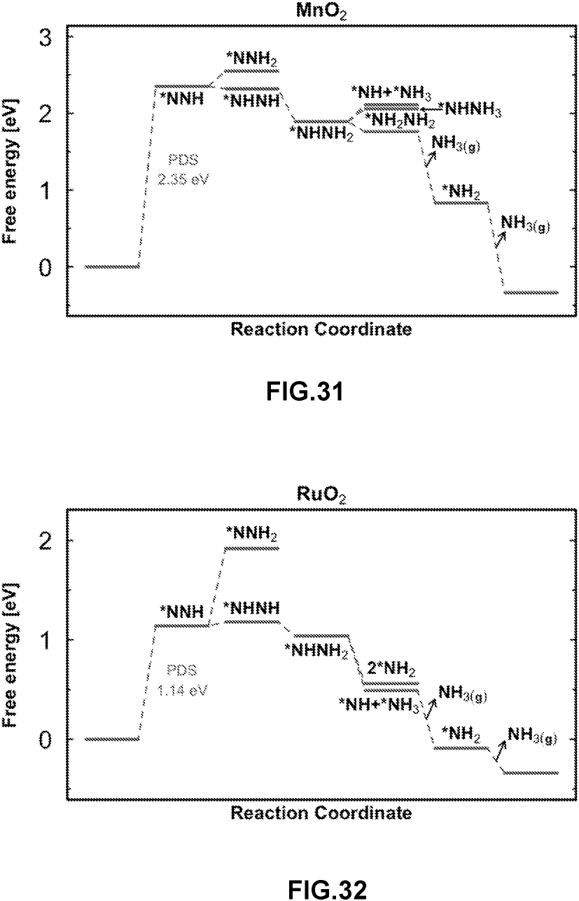

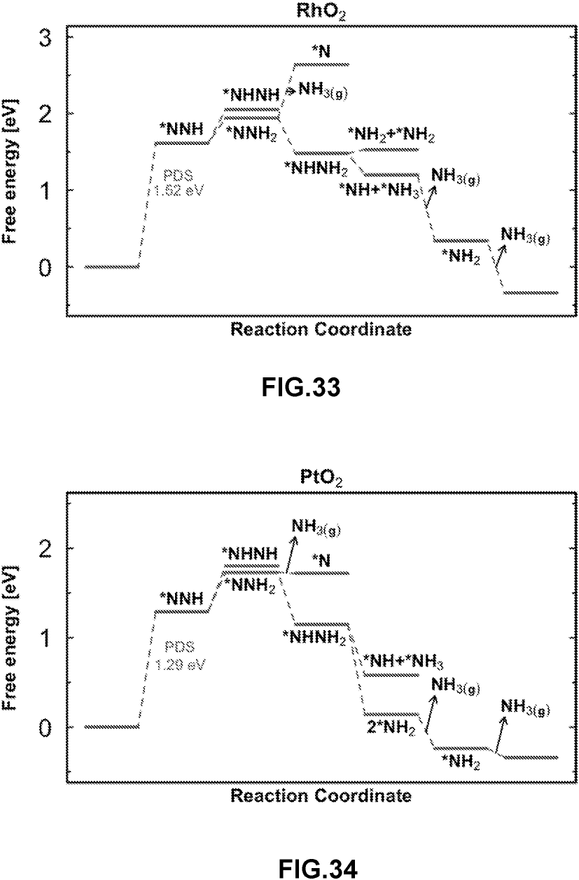

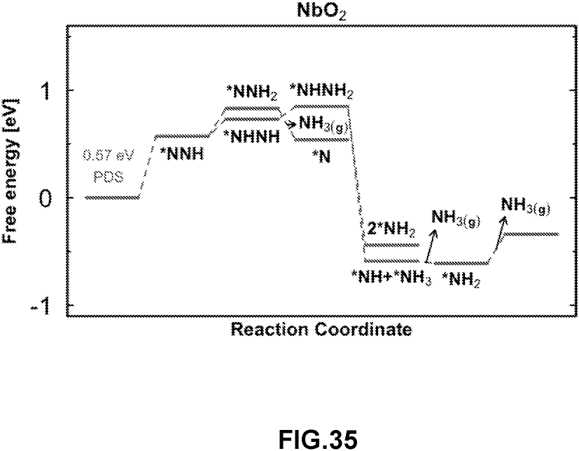

Considering the stability diagram presented in FIG. 2 for NbO₂, the favored surface at the onset potential required for ammonia formation is the H-term for both cases. This excludes the possibility of ammonia formation on the O-term and reduced surface for NbO₂. A similar analysis is made for all the oxides, and the results are presented in FIG. 24. For all the rutile oxides the required applied potential is in the potential range where the H-term surface is favored and seems to eliminate the possibility of ammonia formation on oxygen terminated and reduced surfaces. The free energy change of the PDS for the hydrogen terminated surfaces of lrO₂, NbO₂, OsO₂, ReO₂, RuO₂, TaO₂, PtO₂, RhO₂, CrO₂, TiO₂ and MnO₂ are 0.36 eV, 0.57 eV, 0.60 eV, 1.07 eV, 1.14 eV, 1.21 eV, 1.29 eV, 1.61 eV, 2.04 eV, 2.07 eV and 2.35 eV respectively. Three of these surfaces, lrO₂, NbO₂ and OsO₂, have a required overpotential similar to, or lower than the overpotential required for nitrogen reduction by nitrogensase, but that is believed to be around 0.63 V. The free energy diagrams, showing all possible intermediates for the H-term surface of all the candidates are shown in FIGS. 25-35.

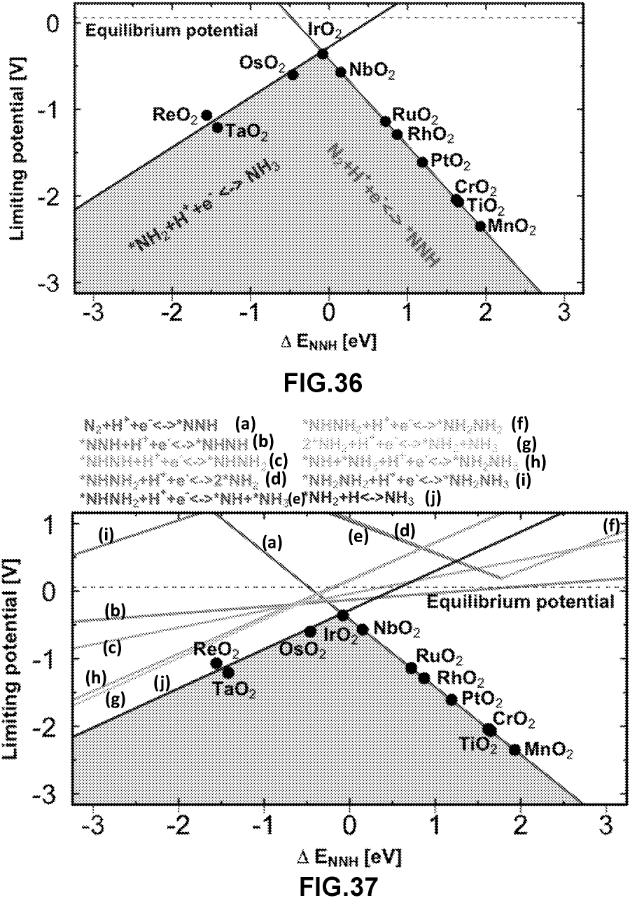

Scaling relations and volcano diagram: Using scaling relations between the binding energies of the various intermediates of the N₂ reduction mechanism, a volcano plot was constructed as shown in FIG. 36. This plot only shows three of the six electrochemical reaction steps of the ammonia formation mechanism. The three steps not included have a y-intercept greater than zero and thus do not affect the conclusions drawn from the plot.

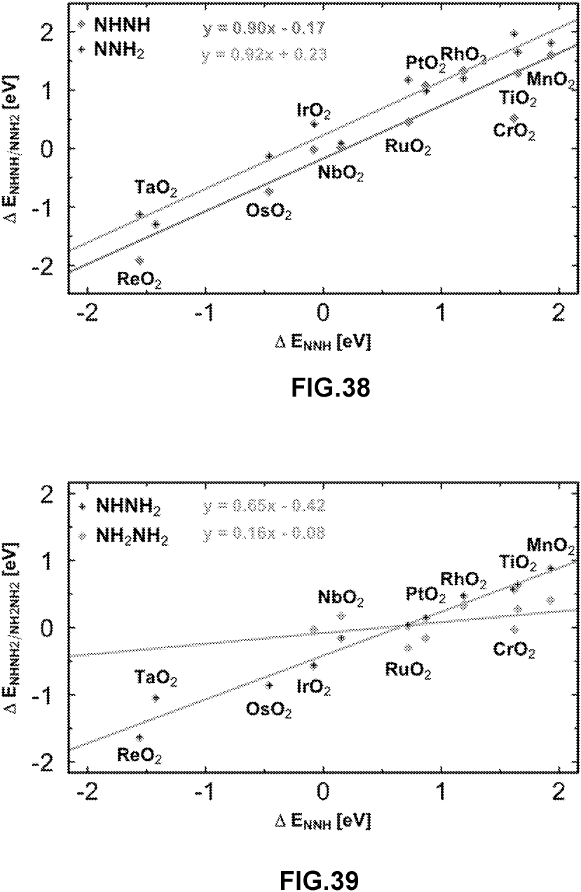

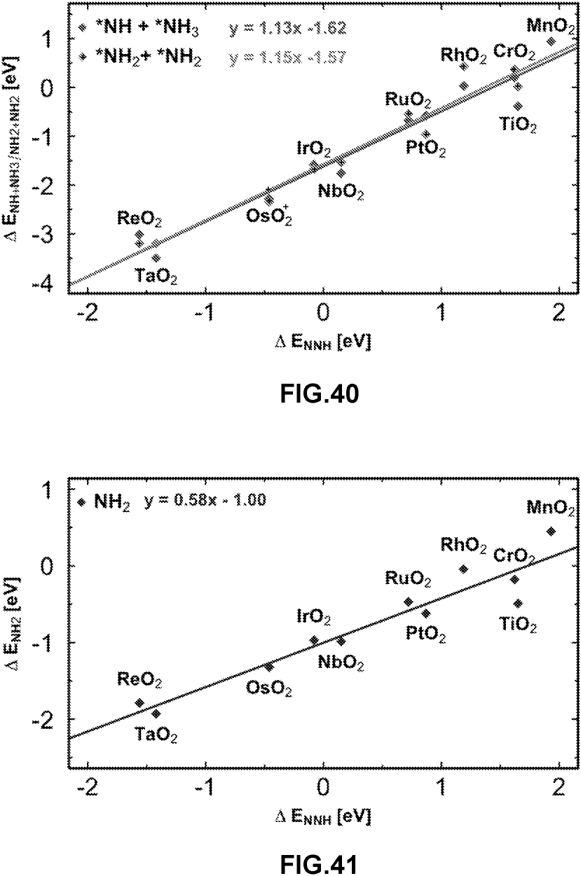

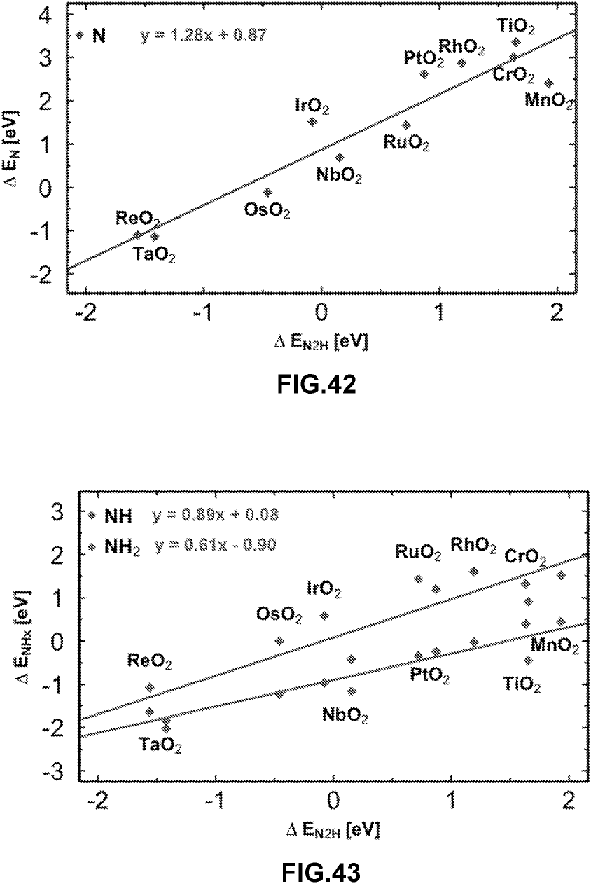

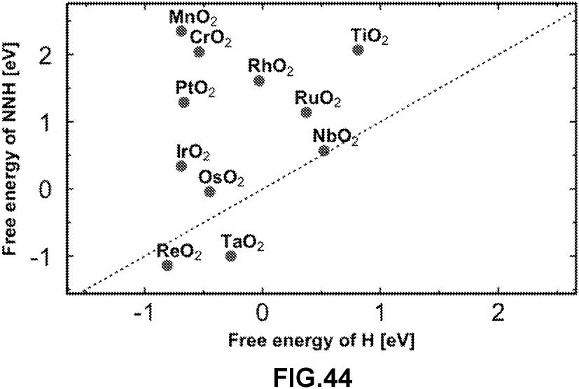

Scaling relations used to calculate the lines in FIGS. 36-37 are shown in FIGS. 38-43, and a plot showing all reaction steps of the ammonia formation mechanism is shown in FIG. 37.

Similar diagrams have previously been constructed for the pure transition metals, where the binding energy of N to the surface was used rather than the binding energy of N₂H. (Skulason 2012, Montoya 2015)

The binding energy of *N is endothermic on all candidates in this work (except ReO₂ and TaO₂) and thus dissociating N₂ would be endothermic as well as having a high activation energy. However, the binding energy of *N on ReO₂ and TaO₂ is around -1 eV and therefore dissociating N₂ might involve a low barrier on those candidates, since there the reaction energy is around -2 eV. The inclusion of the dissociative pathway would however not change the reported PDSs for any candidate, as the *NH₂ ➔NH₃ is the PDS on the left leg of the volcano where ReO₂ and TaO₂ are located. The reaction steps *N ➔ *NH and *NH ➔ *NH₂ are also included in our pathways and those steps never become PDSs (see FIG. 43).

First protonation: Up until this point we haven’t considered competing reactions such as the hydrogen evolution reaction. As a first step towards including competing reactions, we calculate the free energy of the first reaction step of the ammonia formation, which includes the adsorption of N₂H, and compare it to the free energy of hydrogen adsorption on the surface. The hydrogen atom is allowed to find its most favorable binding site on the surface. This is only done for the H-term surfaces, as the other surface terminations have already been eliminated due to instability under operating conditions. The results of this analysis can be seen in FIG. 6. The two oxides ReO₂ and TaO₂, seem to favor the adsorption of N₂H over that of proton and are thus promising for electrochemical ammonia formation at higher yields. NbO₂ binds N₂H and H with similar strength so both species are expected to be on that surface and therefore, we may expect both ammonia and hydrogen gas formation on NbO₂. lrO₂ strongly favors proton adsorption over NNH, which is unfortunate as lrO₂ indeed has the lowest predicted onset potential of the eleven oxides considered in this work. ReO₂ and TaO₂, however, may be active and selective for N₂ electroreduction, but with a slightly larger overpotential.

### Conclusion

DFT calculations were used to explore the possibility of nitrogen activation for electrochemical ammonia at ambient conditions on the (110) facet of the rutile structure of NbO₂, RuO₂, RhO₂, TaO₂, ReO₂, TiO₂, OsO₂, MnO₂, CrO₂, lrO₂ and PtO₂. The relative stability of the facets with different adsorbates was calculated as a function of applied potential. The catalytic activity of each surface was investigated and the potential determining step found. At the applied potential required to make all electrochemical steps downhill in free energy, all the oxides were found to be most stable with hydrogen adsorbed on the sites. Of those oxides, ReO₂ and TaO₂ favor N₂H adsorption.

### References

1. Giddey, S.; Badwal, S. P. S.; Kulkarni, A., Review of electrochemical ammonia production technologies and materials. Int J Hydrogen Energ 2013, 38 (34), 14576-14594.
2. Amar, I. A.; Lan, R.; Petit, C. T. G.; Tao, S. W., Solid-state electrochemical synthesis of ammonia: a review. J Solid State Electr 2011, 15 (9), 1845-1860.
3. Smil, V., Detonator of the population explosion. Nature 1999, 400 (6743), 415-415.
4. Klerke, A.; Christensen, C. H.; Norskov, J. K.; Vegge, T., Ammonia for hydrogen storage: challenges and opportunities. J Mater Chem 2008, 18 (20), 2304-2310.
5. Smil, V., Global population and the nitrogen cycle. Sci Am 1997, 277 (1), 76-81.
6. Jennings, J. R., Catalytic ammonia synthesis: fundamentals and practice. Plenum Press: New York, 1991.
7. Burgess, B. K.; Lowe, D. J., Mechanism of molybdenum nitrogenase. Chem Rev 1996, 96 (7), 2983-3011.
8. Berg, J. M.; Tymoczko, J. L.; Stryer, L., Biochemistry. 5th ed.; W.H. Freeman: New York, 2002.
9. Shipman, M. A.; Symes, M. D., Recent progress towards the electrosynthesis of ammonia from sustainable resources. Catal Today 2017, 286, 57-68.
10. Becker, J. Y.; Posin, B., Nitrogen-Fixation .2. Nitrogen Reduction by Electrochemically Generated Vanadium(II) Promoted by Various Organic-Ligands in Basic Methanol. J Electroanal Chem 1988, 250 (2), 385-397.
11. Becker, J. Y.; Avraham, S., Nitrogen-Fixation .3. Electrochemical Reduction of Hydrazido (-NNH2) Mo and W-Complexes - Selective Formation of NH3 under Mild Conditions. J Electroanal Chem 1990, 280 (1), 119-127.
12. Pickett, C. J.; Talarmin, J., Electrosynthesis of Ammonia. Nature 1985, 317 (6038), 652-653.
13. Sclafani, A.; Augugliaro, V.; Schiavello, M., Dinitrogen Electrochemical Reduction to Ammonia over Iron Cathode in Aqueous-Medium. J Electrochem Soc 1983, 130 (3), 734-735.
14. Yandulov, D. V.; Schrock, R. R., Catalytic reduction of dinitrogen to ammonia at a single molybdenum center. Science 2003, 301 (5629), 76-78.
15. Furuya, N.; Yoshiba, H., Electroreduction of Nitrogen to Ammonia on Gas-Diffusion Electrodes Loaded with Inorganic Catalyst. J Electroanal Chem 1990, 291 (1-2), 269-272.
16. Marnellos, G.; Stoukides, M., Ammonia synthesis at atmospheric pressure. Science 1998, 282 (5386), 98-100.
17. Marnellos, G.; Zisekas, S.; Stoukides, M., Synthesis of ammonia at atmospheric pressure with the use of solid state proton conductors. J Catal 2000, 193 (1), 80-87.
18. Murakami, T.; Nishikiori, T.; Nohira, T.; Ito, Y., Electrolytic synthesis of ammonia in molten salts under atmospheric pressure. J Am Chem Soc 2003, 125 (2), 334-335.
19. Murakami, T.; Nohira, T.; Goto, T.; Ogata, Y. H.; Ito, Y., Electrolytic ammonia synthesis from water and nitrogen gas in molten salt under atmospheric pressure. Electrochim Acta 2005, 50 (27), 5423-5426.
20. Murakami, T.; Nohira, T.; Araki, Y.; Goto, T.; Hagiwara, R.; Ogata, Y. H., Electrolytic synthesis of ammonia from water and nitrogen under atmospheric pressure using a boron-doped diamond electrode as a nonconsumable anode. Electrochem Solid St 2007, 10 (4), E4-E6.
21. Chatt, J.; Pearman, A. J.; Richards, R. L., Reduction of Mono-Coordinated Molecular Nitrogen to Ammonia in a Protic Environment. Nature 1975, 253 (5486), 39-40.
22. Pool, J. A.; Lobkovsky, E.; Chirik, P. J., Hydrogenation and cleavage of dinitrogen to ammonia with a zirconium complex. Nature 2004, 427 (6974), 527-530.
23. Avenier, P.; Taoufik, M.; Lesage, A.; Solans-Monfort, X.; Baudouin, A.; de Mallmann, A.; Veyre, L.; Basset, J. M.; Eisenstein, O.; Emsley, L.; Quadrelli, E. A., Dinitrogen dissociation on an isolated surface tantalum atom. Science 2007, 317 (5841), 1056-1060.
24. Amar, I. A.; Lan, R.; Petit, C. T. G.; Arrighi, V.; Tao, S. W., Electrochemical synthesis of ammonia based on a carbonate-oxide composite electrolyte. Solid State Ionics 2011, 182 (1), 133-138.
25. Murphy, O. J.; Denvir, A. J.; Teodorescu, S. G.; Uselton, K. B., Electrochemical synthesis of ammonia. Google Patents: 2008.
26. Ouzounidou, M.; Skodra, A.; Kokkofitis, C.; Stoukides, M., Catalytic and electrocatalytic synthesis of NH3 in a H+ conducting cell by using an industrial Fe catalyst. Solid State Ionics 2007, 178 (1-2), 153-159.
27. Pappenfus, T. M.; Lee, K.-m.; Thoma, L. M.; Dukart, C. R., Wind to Ammonia: Electrochemical Processes in Room Temperature Ionic Liquids. ECS Transactions 2009, 16 (49), 89-93.
28. Song, Z.; Cai, T. H.; Hanson, J. C.; Rodriguez, J. A.; Hrbek, J., Structure and reactivity of Ru nanoparticles supported on modified graphite surfaces: A study of the model catalysts for ammonia synthesis. J Am Chem Soc 2004, 126 (27), 8576-8584.
29. Xu, G. C.; Liu, R. Q.; Wang, J., Electrochemical synthesis of ammonia using a cell with a Nafion membrane and SmFe0.7Cu0.3-x Ni (x) O-3 (x=0-0.3) cathode at atmospheric pressure and lower temperature. Sci China Ser B 2009, 52 (8), 1171-1175.
30. Lan, R.; Irvine, J. T. S.; Tao, S. W., Synthesis of ammonia directly from air and water at ambient temperature and pressure. Sci Rep-Uk 2013, 3.
31. Skulason, E.; Bligaard, T.; Gudmundsdottir, S.; Studt, F.; Rossmeisl, J.; Abild-Pedersen, F.; Vegge, T.; Jonsson, H.; Norskov, J. K., A theoretical evaluation of possible transition metal electro-catalysts for N2 reduction. Phys Chem Chem Phys 2012, 14 (3), 1235-1245.
32. Abghoui, Y.; Garden, A. L.; Hlynsson, V. F.; Bjorgvinsdottir, S.; Olafsdottir, H.; Skulason, E., Enabling electrochemical reduction of nitrogen to ammonia at ambient conditions through rational catalyst design. Phys Chem Chem Phys 2015, 17 (7), 4909-4918.
33. Abghoui, Y.; Garden, A. L.; Howat, J. G.; Vegge, T.; Skulason, E., Electroreduction of N2 to Ammonia at Ambient Conditions on Mononitrides of Zr, Nb, Cr, and V: A DFT Guide for Experiments. Acs Catal 2016, 6 (2), 635-646.
34. Abghoui, Y.; Skulason, E., Electrochemical synthesis of ammonia via Mars-van Krevelen mechanism on the (111) facets of group III-VII transition metal mononitrides. Catal Today 2017, 286, 78-84.
35. Abghoui, Y.; Skulason, E., Onset potentials for different reaction mechanisms of nitrogen activation to ammonia on transition metal nitride electro-catalysts. Catal Today 2017, 286, 69-77.
36. Abghoui, Y.; Skulason, E., Computational Predictions of Catalytic Activity of Zincblende (110) Surfaces of Metal Nitrides for Electrochemical Ammonia Synthesis. J Phys Chem C 2017, 121 (11), 6141-6151.
37. Howalt, J. G.; Vegge, T., Electrochemical ammonia production on molybdenum nitride nanoclusters. Phys Chem Chem Phys 2013, 15 (48), 20957-20965.
38. Howalt, J. G.; Vegge, T., The role of oxygen and water on molybdenum nanoclusters for electro catalytic ammonia production. Beilstein J Nanotech 2014, 5, 111-120.
39. Abghoui, Y.; Skúlasson, E., Transition Metal Nitride Catalysts for Electrochemical Reduction of Nitrogen to Ammonia at Ambient Conditions. Procedia Computer Science 2015, 51, 1897-1906.
40. Norskov, J. K.; Rossmeisl, J.; Logadottir, A.; Lindqvist, L.; Kitchin, J. R.; Bligaard, T.; Jonsson, H., Origin of the overpotential for oxygen reduction at a fuel-cell cathode. J Phys Chem B 2004, 108 (46), 17886-17892.
41. Kung, H. H., Transition metal oxides : surface chemistry and catalysis. Elsevier; Distributors for the U.S. and Canada, Elsevier Science Pub. Co.: Amsterdam, The Netherlands, ; New York New York, NY, U.S.A., 1989.
42. Hammer, B.; Hansen, L. B.; Norskov, J. K., Improved adsorption energetics within density-functional theory using revised Perdew-Burke-Ernzerhof functionals. Phys Rev B 1999, 59 (11), 7413-7421.
43. Blochl, P. E., Projector Augmented-Wave Method. Phys Rev B 1994, 50 (24), 17953-17979.
44. Kresse, G.; Hafner, J., Abinitio Molecular-Dynamics for Liquid-Metals. Phys Rev B 1993, 47 (1), 558-561.
45. Kresse, G.; Hafner, J., Ab-Initio Molecular-Dynamics Simulation of the Liquid-Metal Amorphous-Semiconductor Transition in Germanium. Phys Rev B 1994, 49 (20), 14251-14269.
46. Kresse, G.; Furthmuller, J., Efficiency of ab-initio total energy calculations for metals and semiconductors using a plane-wave basis set. Comp Mater Sci 1996, 6 (1), 15-50.
47. Kresse, G.; Furthmuller, J., Efficient iterative schemes for ab initio total-energy calculations using a plane-wave basis set. Phys RevB 1996, 54 (16), 11169-11186.
48. Skulason, E.; Tripkovic, V.; Bjorketun, M. E.; Gudmundsdottir, S.; Karlberg, G.; Rossmeisl, J.; Bligaard, T.; Jonsson, H.; Norskov, J. K., Modeling the Electrochemical Hydrogen Oxidation and Evolution Reactions on the Basis of Density Functional Theory Calculations. J Phys Chem C 2010, 114 (42), 18182-18197.
49. Tripkovic, V.; Skulason, E.; Siahrostami, S.; Norskov, J. K.; Rossmeisl, J., The oxygen reduction reaction mechanism on Pt(111) from density functional theory calculations. Electrochim Acta 2010, 55 (27), 7975-7981.
50. Montoya, J. H.; Tsai, C.; Vojvodic, A.; Norskov, J. K., The Challenge of Electrochemical Ammonia Synthesis: A New Perspective on the Role of Nitrogen Scaling Relations. Chemsuschem 2015, 8 (13), 2180-2186.
51. Morgan, B. J.; Watson, G. W., A DFT+U description of oxygen vacancies at the TiO2 rutile (110) surface. Surf Sci 2007, 601 (21), 5034-5041.
52. Abild-Pedersen, F.; Greeley, J.; Studt, F.; Rossmeisl, J.; Munter, T. R.; Moses, P. G.; Skulason, E.; Bligaard, T.; Norskov, J. K., Scaling properties of adsorption energies for hydrogen-containing molecules on transition-metal surfaces. Phys Rev Lett 2007, 99 (1).

1. A process for producing ammonia comprising:
feeding N₂ to an electrolytic cell that comprises at least one source of protons;
allowing the N₂ to come into contact with a cathode electrode surface in the electrolytic cell, wherein the cathode electrode surface comprises a catalyst surface comprising at least one transition metal oxide; and
running a current through said electrolytic cell, whereby nitrogen reacts with protons to form ammonia.

2. The process of claim 1, wherein the catalyst comprises one or more transition metal oxide selected from the group consisting of Titanium oxide, Chromium oxide, Manganese oxide, Niobium oxide, Tantalum oxide, Ruthenium oxide, Rhodium oxide, Platinum oxide, Osmium oxide, Rhenium oxide and Iridium oxide.

3. The process of claim 2, wherein the catalyst comprises one or more oxide selected from the group consisting of Rhenium oxide, Tantalum oxide and Niobium oxide.

4. The process of claim 1 wherein the catalyst surface comprises at least one surface having a rutile structure.

5. The process of claim 1, wherein the catalyst surface comprises at least one surface having a (110) facet.

6. The process of claim 1, wherein ammonia is formed in the electrolytic cell at an electrode potential at less than about -1.0 V, more preferably less than about -0.8 V and even more preferably less than about -0.5 V.

7. The process of -claim 1, wherein the catalyst comprises Niobium oxide, and wherein ammonia is formed in the electrolytic cell at an electrode potential at less than about -0.5 V.

8. The process of claim 1, wherein the catalyst comprises Rhenium oxide, and wherein ammonia is formed in the electrolytic cell at an electrode potential at less than about -0.9 V rom.

9. The process of claim 1, wherein the catalyst comprises Tantalum oxide, and wherein ammonia is formed in the electrolytic cell at an electrode potential at less than about -1.1 V
.

10. The process of claim 1, wherein less than 50% moles H₂ are formed compared to moles NH₃ formed.

11. The process of claim 1, wherein said electrolytic cell comprises one or more aqueous electrolytic solution.

12. The process of claim 1, wherein said electrolytic cell comprises an electrolytic solution comprising a organic protic or aprotic solvent, or a miscible mixture thereof, preferably a water-miscible organic solvent.

13. The process of claim 11 wherein said nitrogen is fed to the electrolytic cell by bubbling nitrogen gas to electrolytic solution in contact with said cathode electrode surface.

14. The process of of claim 1, wherein the source of protons in the formation of ammonia is from water splitting at the anode or H₂ oxidation reaction at the anode.

15. The process of claim 1, operated at a temperature in the range from about -10 ° to about 40° C. and.

16. The process of claim 1, operated at an ambient room temperature and atmospheric pressure.

17. A system for generating ammonia, the system comprising at least one electrochemical cell, which comprises at least one cathode electrode having a catalytic surface, wherein the catalytic surface is charged with at least one catalyst comprising one or more transition metal oxide.

18. The system of claim 17, wherein said one or more transition metal oxide is selected from the group consisting of Titanium oxide, Chromium oxide, Manganese oxide, Niobium oxide, Tantalum oxide, Ruthenium oxide, Rhodium oxide, Platinum oxide, Osmium oxide, Rhenium oxide and Iridium oxide.

19. The system of claim 17 , wherein the at least one transition metal oxide is selected from the group consisting of Rhenium oxide, Tantalum oxide and Niobium oxide.

20. The system of -claim 17, wherein the catalyst surface comprises at least one surface having a rutile structure.

21. The system of -claim 17, wherein the catalyst surface comprises at least one surface having a (110) facet.

22. The system of claim 17, wherein said electrolytic cell further comprises one or more electrolytic solution.

23. The system of claim 22, wherein said electrolytic cell comprises an acidic, neutral or alkaline aqueous solution.

24. The system of claim 22, wherein said electrolytic cell comprises an electrolytic solution comprising a organic protic or aprotic solvent, or a miscible mixture thereof.

25. The system of claim 17, which is configured to produce ammonia in the electrolytic cell at an electrode potential at less than about -1.0 V, preferably.

26. The system of claim 25, wherein the catalyst comprises Niobium oxide, and wherein the system is configured to produce ammonia in the electrolytic cell at an electrode potential at less than about -0.5 V.

27. The system of claim 25, wherein the catalyst comprises Rhenium oxide, and wherein the system is configured to produce ammonia in the electrolytic cell at an electrode potential at less than about -0.9 V.

28. The system of 17, wherein the catalyst comprises Tantalum oxide, and wherein the system is configured to produce ammonia in the electrolytic cell at an electrode potential at less than about -1.1 V.
